(19) United States
(12) Patent Application Publication
(10) Pub. No.: US 2007/0297291 A1
(43) Pub. Date: Dec. 27, 2007

(54) MAINTENANCE PANEL FOR A GENERATOR

(75) Inventor: Jere B. Albright JR., Kearney, NE (US)

Correspondence Address: LEYDIG, VOIT & MAYER, LTD.;(SEATTLE OFFICE), TWO PRUDENTIAL PLAZA, SUITE 4900, CHICAGO, IL, 60601-6731, US

(73) Assignee: POWERMATE CORPORATION, Aurora, IL (US)

(21) Appl. No.: 11/852,600

(22) Filed: Sep. 10, 2007

Related U.S. Application Data
(63) Continuation-in-part of application No. 11/557,625, filed on Nov. 8, 2006.
(60) Provisional application No. 60/734,475, filed on Nov. 8, 2005.

(51) Int. Cl. G04F 10/00

(52) U.S. Cl. 368/5

(57) ABSTRACT

A generator having a display having two or more resettable timers. The timers provide a signal to indicate a maintenance reminder.

### REFERENCE TO RELATED APPLICATIONS

This application is a continuation in part of U.S. application Ser. No. 11/557,625, filed Nov. 8, 2006, which claims priority to U.S. provisional patent application Ser. No. 60/734,475, filed Nov. 8, 2005, both of which are incorporated herein by reference.

### TECHNICAL FIELD OF THE INVENTION

The present invention relates generally to generators, and more particularly to control displays for a generator.

### BACKGROUND OF THE INVENTION

A generator is a machine or device that is used to convert mechanical energy, such as that provided by the combustion of fuel, into electricity.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

An embodiment provides a character-based LCD (liquid crystal display) display that is “on” whenever the generator is running. The meter displays at least one of three resettable timers representing time since last reset, intended to remind the user when to change oil, change the air filter, or check a spark plug. Other maintenance reminders may be provided.

Other features of the invention will become apparent from the following detailed description when taken in conjunction with the drawings, in which:

### BRIEF DESCRIPTION OF THE DRAWINGS

FIG. 1 is a representation of a display in accordance with a first embodiment; and

FIG. 2 is a representation of a display in accordance with a second embodiment.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

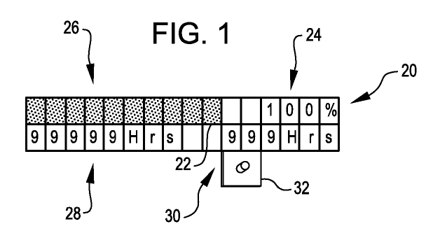

Referring now to the drawings, in which like reference numerals represent like parts throughout the several views, FIG. 1 shows a display, called an LCD panel meter 20, that may be used with a generator (not shown, but known) in accordance with an embodiment.

The LCD panel meter 20 includes a character-based LCD display 22 that is “on” when the generator is running. The LCD panel meter 20 simultaneously displays at least four items: 1) power output 24 as a percentage of the generator's continuous rated output, 2) a graphical bar 26 that corresponds to the percentage shown in item #1, 3) a non-resettable timer 28 displaying the total run time of the generator since manufacture, and 4) a resettable timer 30 displaying time since last reset, intended to remind the user when to change oil or perform other maintenance. A subset of these items may be displayed, or additional information may be displayed.

Other configurations may also be used. For example, other ways of displaying the items may be used, such as an array of LEDs (light emitting diodes) or other means of displaying information.

In an embodiment, the non-resettable timer 28 may actually be resettable (for example, by repair personnel). In such an embodiment, the resetting mechanism may be hidden from user access and/or may require a special tool that is generally available to the manufacturer and/or repair technicians. Also, the non-resettable timer 28 may track time other than “since manufacture.” As an example, the non-resettable timer 28 may track time from a particular time in the generator's life cycle, such as the time when it was rebuilt or the time when the display 20 was installed on the generator. The non-resettable timer 28 may also have the ability to be set to any particular time. For example, a replacement panel meter 20 may be set to the time on the panel meter that is being replaced.

In an embodiment, the non-resettable timer 28 and the resettable timer 30 may alternatively be shown in the same portion of the panel meter 20 and there may be a button (not shown) or other actuation mechanism for toggling between the displays of the non-resettable timer 28 and the resettable timer 30. Both timers 28, 30 count up from zero in hours, although other increments may be used.

In an embodiment, the LCD panel meter 20 has a reset button 32 to enable a user to reset the maintenance timer 30. As shown in FIG. 1, the reset button 32 is on the LCD panel meter 20 itself, but may be in other locations on a generator. For example, the button 32 may be anywhere if it is electrically, wirelessly, or otherwise connected to the device 20.

In the rear of the device, protected from user access, is a multi-pole dual in-line package (DIP) switch (not shown, but known). The DIP switch enables the factory to set each meter 28, 30 to correspond to any one of several predetermined rated power values, allowing one meter to work for many different size generators. The LCD panel meter 20 may also not have a DIP-switch and/or may also include other features.

Methods for measuring the information provide by the LCD panel meter 20 are known, but an example follows for the benefit of the reader. The LCD panel meter 20 is electrically connected to the power output winding(s) of a generator in order to power the circuits and to measure the operating voltage. Additionally, the generator power output leads are passed through a current transformer (not shown, but known) on or otherwise associated with the LCD panel meter 20 in order to measure the operating current. The product of operating current times voltage results in operating power (watts). The percent load is the result of dividing the operating power by rated power (as indicated by the DIP-switch). Meter range is 0%-100% in increments of 5% for both the numeric readout and the graphical readout. Other ranges may be used. For example, the maximum value of the meter range may exceed 100% in order to indicate when the operating power exceeds the rated operating power. In addition, the device 20 may be programmed to show 100% whenever the output power is equal to or exceeds the rated power.

These calculations, along with calculations for the two timers, are continuously updated in real time by an on-board microcontroller (not shown). This microcontroller then sends appropriate signals to drive the LCD display. Other ways for updating the calculations may be used. For example, the calculations may be updated at predetermined or other intervals. The microcontroller may round calculations to the nearest displayable value.

The microcontroller may be a standard control (i.e., a device or mechanism used to regulate or guide the operation of a machine, apparatus, or system), a microcomputer, or any other device that can execute computer-executable instructions, such as program modules. Generally, program modules include routines, programs, objects, components, data structures and the like that perform particular tasks or implement particular abstract data types. A programmer of ordinary skill in the art can program or configure the microcontroller to perform the functions described herein.

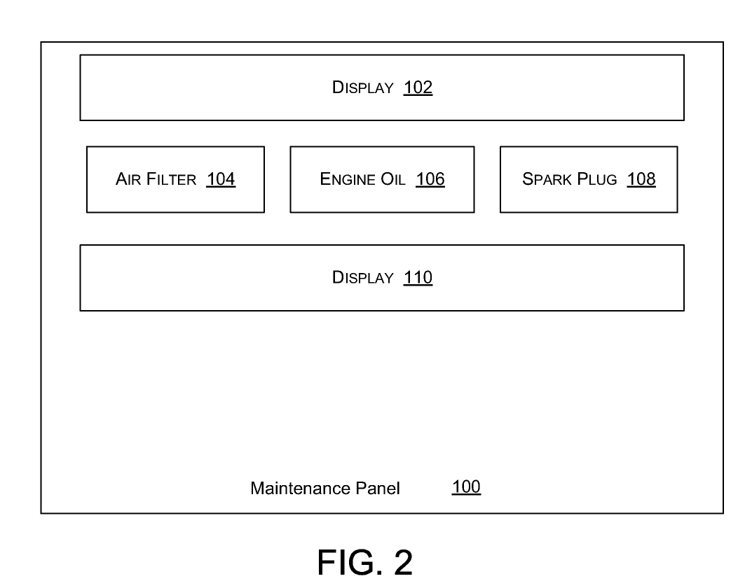

FIG. 2 is a representation of a display of a maintenance panel 100 in accordance with another embodiment. The maintenance panel 100 includes a display 102, such as a LCD display. In addition, the panel includes two or more resettable buttons, similar to the reset button 32. In the embodiment shown in the drawings, an air filter reset button 104, and engine oil reset button 106, and a spark plug reset button 108 are provided. However, any subset of two of these buttons and/or additional or alternative buttons may be provided to provide maintenance features for different functions. If desired, a separate display 110 may be provided. In an alternate embodiment, the functions of the displays 102 and 110 are provided in a single display.

In accordance with an embodiment, each maintenance operation associated with the button 104, 106, or 108 includes an amount of time associated therewith. For example, for the air filter check button, a time of 50 hours may be associated with that operation. During operation, a timer maintains operating time up to the 50 hour point. At that point, a signal is generated. In an embodiment, the signal may be the display 102 displaying the terms “CHECK AIR FILTER.” This indicator is an instruction to a user to check the cleanliness of the air filter. After checking the air filter, the user may utilize the button 104 to reset the timer. As an example, the user may press and hold the button for a period of time (e.g., 3 seconds) to reset the timer back to 00.

Similarly, the other buttons 106, 108 may each be associated with a time period. As an example, the change oil resettable button 106 may be associated with 100 hours. Again, when this time period has been reached, a signal may be generated, and an indicator may be provided, e.g., the display 102 may show “CHANGE OIL.” Again, if desired, to reset, a user may press the button 106 and hold for a predetermined amount of time, such as three seconds. The spark plug resettable button 108 may include a similar message after a period of time, such as 100 hours. This message may be, for example, “CHECK SPARK PLUG.” After the spark plug has been checked by a user, that user may reset the timer by pressing and holding the button 108.

If desired, the display 110 may be utilized to show a visual representation of a counting up or down of the time since reset. Thus, separate counters may be displayed on the display 110 that are associated with each of the buttons 104, 106, and 108. These counters and other information may be provided on either or both of the displays 102, 110.

Other indicators may be used to indicate that a resettable time period has elapsed. The indicator may be, for example, an alarm, a flashing light, a recorded voice, or another appropriate signal. Such an indicator may be used with or without a display.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A generator comprising:
a display comprising at least two of the set of:
(a) a resettable oil change timer displaying the time since a last reset;
(b) a resettable air filter timer displaying the time since a last reset; and
(c) a resettable spark plug timer displaying the time since a last reset.

2. The generator of claim 1, further comprising, for each resettable timer, a button for resetting the resettable timer.

3. The generator of claim 2, further comprising, for each button, a delay after which the resettable timer is reset.

4. The generator of claim 1, wherein the set comprises:
(a) a resettable oil change timer displaying the time since a last reset;
(b) a resettable air filter timer displaying the time since a last reset; and
(c) a resettable spark plug timer displaying the time since a last reset.

5. The generator of claim 1, wherein the set comprises:
a resettable oil change timer displaying the time since a last reset; and
a resettable air filter timer displaying the time since a last reset.

6. The generator of claim 1, wherein the set comprises:
a resettable oil change timer displaying the time since a last reset; and
a resettable spark plug timer displaying the time since a last reset.

7. The generator of claim 1, wherein the set comprises:
a resettable air filter timer displaying the time since a last reset; and
a resettable spark plug timer displaying the time since a last reset.

8. A generator comprising:
an indicator comprising at least two of the set of:
(a) a resettable oil change timer configured to generate a signal as a result of a first preset time elapsing since a last reset;
(b) a resettable air filter timer configured to generate a signal as a result of a second preset time elapsing since a last reset; and
(c) a resettable spark plug timer configured to generate a signal as a result of a third preset time elapsing since a last reset.

9. The generator of claim 8, further comprising, for each resettable timer, a button for resetting the resettable timer.

10. The generator of claim 9, further comprising, for each button, a delay after which the resettable timer is reset.

11. The generator of claim 8, wherein the set comprises:
(a) a resettable oil change timer configured to generate a signal as a result of a first preset time elapsing since a last reset;
(b) a resettable air filter timer configured to generate a signal as a result of a second preset time elapsing since a last reset; and
(c) a resettable spark plug timer configured to generate a signal as a result of a third preset time elapsing since a last reset.

12. The generator of claim 8, wherein the set comprises:
a resettable oil change timer configured to generate a signal as a result of a first preset time elapsing since a last reset; and
a resettable air filter timer configured to generate a signal as a result of a second preset time elapsing since a last reset.

13. The generator of claim 8, wherein the set comprises:
a resettable oil change timer configured to generate a signal as a result of a first preset time elapsing since a last reset; and
a resettable spark plug timer configured to generate a signal as a result of a third preset time elapsing since a last reset.

14. The generator of claim 8, wherein the set comprises:
a resettable spark plug timer configured to generate a signal as a result of a third preset time elapsing since a last reset; and
a resettable air filter timer configured to generate a signal as a result of a second preset time elapsing since a last reset.
